(19) United States
(12) Patent Application Publication
(10) Pub. No.: US 2002/0068139 A1
(43) Pub. Date: Jun. 6, 2002

(54) Foamed starch structures & methods for making them

(76) Inventors: Brent T. Polak, Midland, MI (US); Marie S. Winkler, Lake Jackson, TX (US); Donald E. Kirkpatrick, Lake Jackson, TX (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/729,561

(22) Filed: Dec. 4, 2000

(51) Int. Cl. B32B 1/02; B29C 44/24

(52) U.S. Cl. 428/36.5; 428/156; 428/167; 156/78; 264/45.9

(57) ABSTRACT

Article of manufacture comprising (i) a sheet of a foamed mixture of starch and at least one of, a polyhydroxy ether, a poly(hydroxy amino ether), a poly(hydroxy ether sulfonamide), a poly(hydroxy ether sulfide), a poly(hydroxy amide ether), or polyvinyl alcohol and (ii) a barrier layer. Specifically, a beverage cup or ice chest with foamed starch/polymer core layer.

### BACKGROUND OF THE INVENTION

1. Field Of The Invention

This invention is directed to foamed starch structures and methods for making them, articles made from them, and methods for making such articles.

2. Description of Related Art

The prior art discloses a wide variety of materials and laminates employing foam material useful for such diverse things as construction components, panels including insulation panels, receptacles, containers, boxes, cartons and cups. Many of these materials include a foam layer and a laminate, film, or sheet layer on one or on both sides of the foam layer. Often paper or cardboard is used for on one or both surfaces of a layer of foam.

The prior art discloses a wide variety of foam material used for a foam layer, including, but not limited to, foamed polystyrene material, polyurethane foams, polyethylene foams, isocyanurate foams, SBR foams, and EVA foams. In general, a “foam” material is one that has been processed or treated to encapsulate or capture within the material numerous cells or bubbles, thereby expanding the material from its original volume and producing a final foam product that in its stable state remains in the expanded increased-volume form.

Many prior art foams—such as polystyrene, polyethylene and polyurethane foams, either take a relatively long time to biodegrade or are not biodegradable.

Prior art sheets of foamed starch have been used as packaging material, either as single sheets or multiple sheets adhered to each other. Pieces of foamed starch have been used for loose fill packing material or “peanuts.” Prior art children's toys include relatively small starch objects similar to the packaging “peanuts” in size and in shape which are easily stuck together by applying moisture to them.

There has long been a need for efficient and effective foamed starch structures and laminates. There has long been a need for such structures and laminates that can be easily formed into useful objects. There has long been a need for such useful objects that are substantially biodegradable. Those skilled in the art also have the benefit of this invention's teachings and will appreciate that the present invention satisfies these needs recognized by the present inventors.

### SUMMARY OF THE PRESENT INVENTION

The present invention, in certain aspects, discloses a foamed starch structure that has a foamed starch layer to which is adhered at least one additional barrier member, a flexible or rigid sheet or layer of paper, paperboard, cardboard, paper-like material or sheet material (e.g. rubber, plastic, fiberglass, polytetrafluoroethylene, etc.). In certain aspects such a sheet or layer, etc. is on each of two spaced-apart flat surfaces of a foamed starch layer. The sheet or layer, etc. may have a moisture-resistant film on surfaces thereof.

In certain embodiments of the present invention, articles, including but not limited to cups, boxes, containers, and plates, are made from one or more foamed starch structures or sheets according to the present invention. In certain methods according to the present invention one or more barrier members, e.g. one or more sheets or layers of paper etc. and/or of sheet material, are adhered to surface(s) of a foamed starch sheet or layer to produce a foamed starch structure according to the present invention.

What follows are some of, but not all, the objects of this invention. In addition to the specific objects stated below for at least certain preferred embodiments of the invention, other objects and purposes will be readily apparent to one of skill in this art who has the benefit of this invention's teachings and disclosures. It is, therefore, an object of at least certain preferred embodiments of the present invention to provide:

New, useful, unique, efficient, nonobvious foamed starch structures and articles made from them; and

New, useful, unique, efficient, nonobvious methods for making such foamed starch structures and articles.

Certain embodiments of this invention are not limited to any particular individual feature disclosed here, but include combinations of them distinguished from the prior art in their structures and functions. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the previously-mentioned problems and long-felt needs and provides a solution to those problems and a satisfactory meeting of those needs in its various possible embodiments and equivalents thereof. To one skilled in this art who has the benefits of this invention's realizations, teachings, disclosures, and suggestions, other purposes and advantages will be appreciated from the following description of preferred embodiments, given for the purpose of disclosure, when taken in conjunction with the accompanying drawings. The detail in these descriptions is not intended to thwart this patent's object to claim this invention no matter how others may later disguise it by variations in form or additions of further improvements.

### BRIEF DESCRIPTION OF THE DRAWINGS

A more particular description of embodiments of the invention briefly summarized above may be had by references to the embodiments which are shown in the drawings which form a part of this specification. These drawings illustrate certain preferred embodiments and are not to be used to improperly limit the scope of the invention which may have other equally effective or legally equivalent embodiments.

FIG. 1A is a top view of a prior art sheet of foamed starch.

FIG. 1B is an end view of the sheet of FIG. 1A.

FIG. 2A is an end view of a foamed starch structure according to the present invention. FIG. 2B is a bottom view and FIG. 2C is a top view (as viewed in FIG. 2A) of the structure of FIG. 2A.

FIG. 3 is an end view of a foamed starch structure according to the present invention.

FIG. 4A is a perspective view of a cup made from a foamed starch structure according to the present invention. FIG. 4B is an exploded view of the piece of structure used to make the cup of FIG. 4A. FIG. 4C is a cross-section view of the sheet of FIG. 4B.

FIG. 5 is a cross-section view of a cup or container according to the present invention made of foamed starch structure according to the present invention.

FIG. 6 is a cross-section view of a cup or container according to the present invention made of foamed starch structure according to the present invention.

FIG. 7 is a cross-section view of a cup or container according to the present invention made of foamed starch structure according to the present invention.

FIGS. 8 and 9 are schematic views of systems for making a foamed starch structure according to the present invention.

FIGS. 10-14 are side cross-section views of foamed starch structures according to the present invention.

FIG. 15 is a perspective view of a box according to the present invention.

FIG. 16A is a top view of a container according to the present invention. FIG. 16B is a view along line 16B-16B of FIG. 16A.

FIG. 17 is a perspective view of a foamed starch structure according to the present invention.

### DESCRIPTION OF CERTAIN PREFERRED EMBODIMENTS

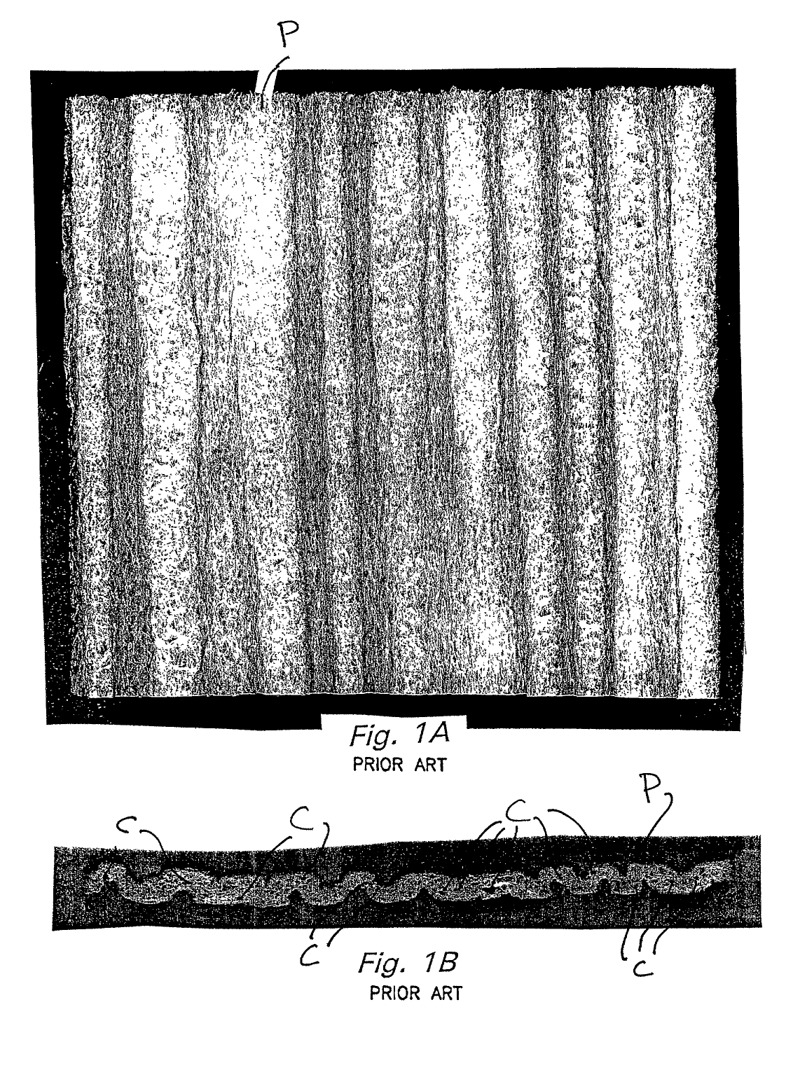

FIGS. 1A and 1B show a piece P of prior art foamed starch which has numerous interstitial cells (also called bubbles or pores) C of varying size and volume throughout the piece P (some of which cells C are not labelled). The piece P has an undulating shape when viewed in cross section as in FIG. 1B.

The undulating shape of the piece P is a result of an extrusion process in which a sheet is extruded from which the piece P is then cut. As shown, the undulations are non-uniform in shape and size; but it is within the scope of this invention for the undulations to be uniform in size and shape. The sheet is produced by an extruder with an “annular” die that has a circular ring-shaped opening. Alternatively a flat sheet die may be used. For producing packing “peanuts” a die with a cutter apparatus is used. Initially the sheet is extruded as a tube which is slit and then the resulting sheet is laid flat.

Material as shown in FIGS. 1A and 1B has been used as the prior art packaging material described above, either compressed or non-compressed.

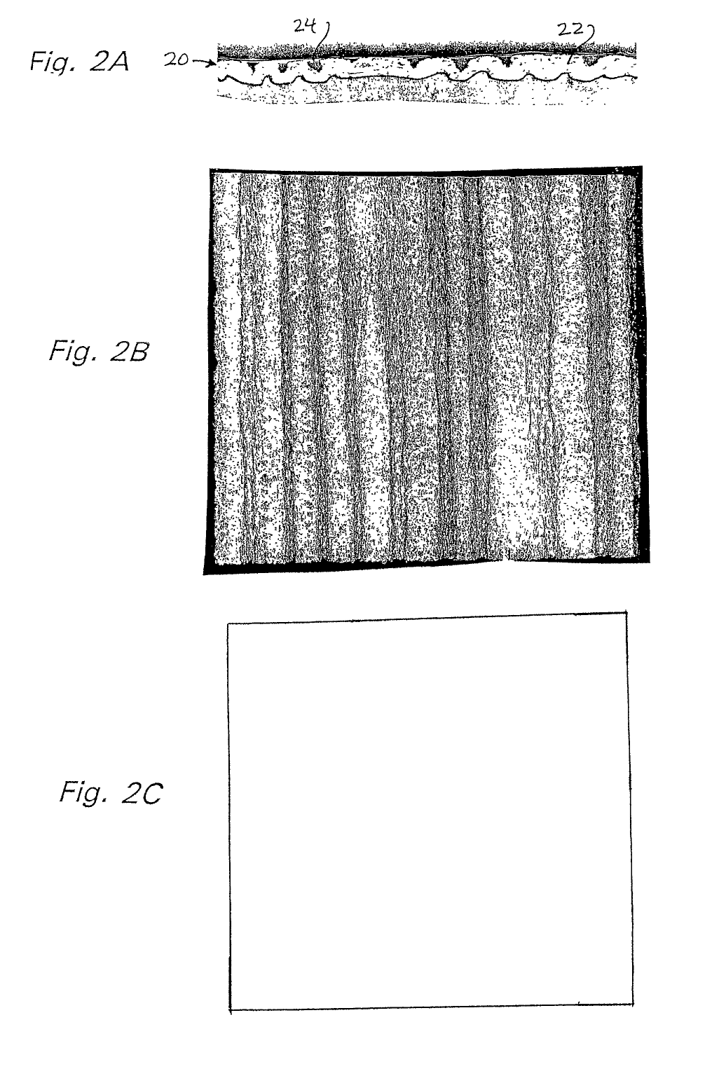

FIG. 2 shows a structure 20 according to the present invention which includes a foamed starch layer 22 (e.g. as in the material of FIG. 1A) with a barrier member, a sheet of paper 24 adhered to the foamed starch layer 22. The piece P is shown in FIG. 1A substantially to scale, but according to the present invention for any embodiment herein, a piece of any desirable size and dimensions may be used. It is within the scope of this invention to adhere the paper 24 to the foam layer 22 with any suitable known glue or adhesive; or to wet the foam layer 22 with water and/or other liquid to make the starch tacky and to adhere it to the paper. The paper 24 in one aspect is glued to the foamed starch layer 22 with commercially available Elmer's glue. It is within the scope of this invention to apply a second paper layer (not shown) opposite the paper 14 on the other side of the foam layer 22.

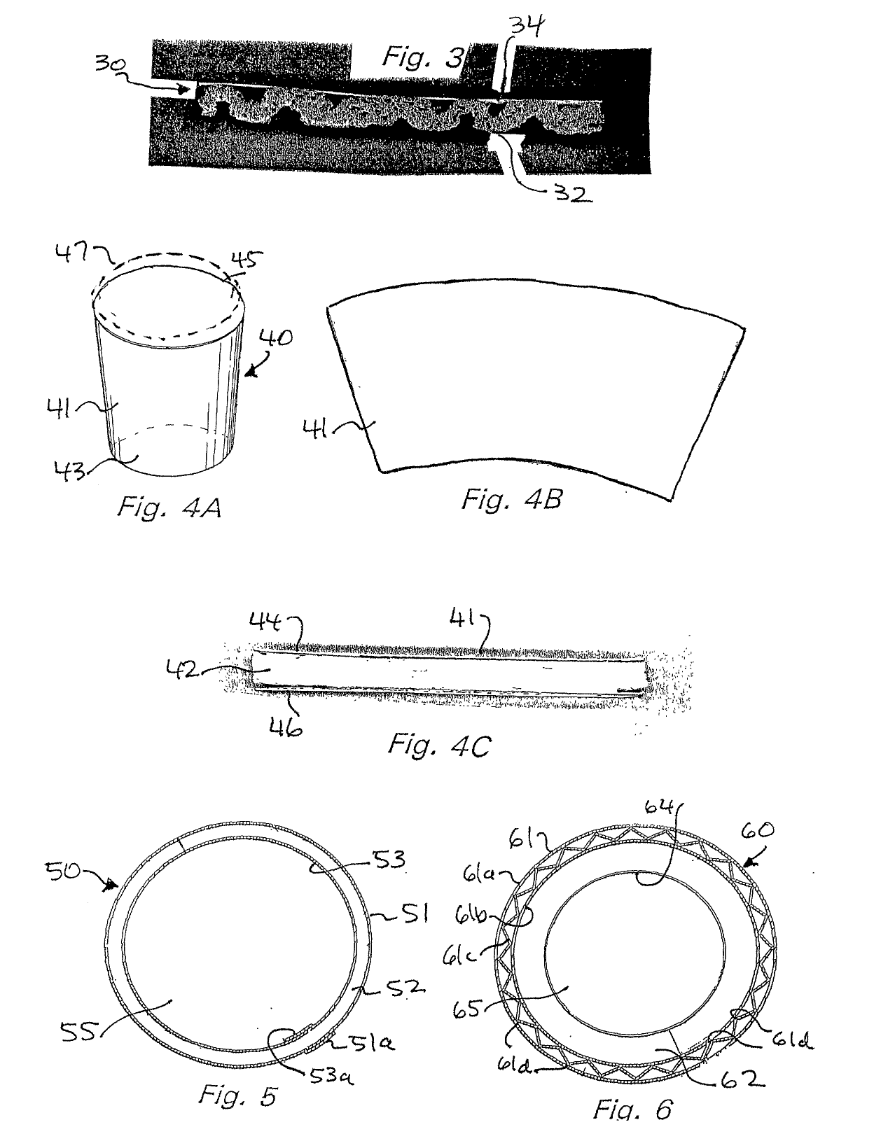

FIG. 3 shows a structure 30 according to the present invention that includes a layer 32 of foamed starch material (as in FIG. 1A) to which is adhered a barrier member, a layer of paper 34 with commercially available Elmer's glue. It is within the scope of this invention to adhere the paper 34 to the layer 32 with any suitable known adhesive; or to wet the foamed starch layer 32 and apply the paper to the wet layer. The paper 34 is the commercially available paperboard as used in Model No. 2342 DIXIE™ 12 ounce “HOT CUP” made by James River Corporation, Norwalk Conn. It is within the scope of this invention to adhere a second paper layer (not shown) on the other side of the foamed starch layer 32.

FIG. 4A shows a cup 40 according to the present invention having a sidewall 41, a bottom 43, and an open top end 45. An optional lid (not shown) may be used with the cup 40 (and with any cup disclosed herein). The optional lid may be made of any material disclosed herein or of any suitable plastic. FIG. 4B shows the sidewall 41 prior to it being formed into the generally cylindrical shape it has in the cup 40 as in FIG. 4A. An optional removable lid 47 (shown in dotted lines, FIG. 4A) may be used with the cup 40. The lid 47 may be any suitable known cup lid and any suitable known structure on the lid and/or on the cup may be used so that it is emplaceable on the cup to selectively close off the open top 47.

FIG. 4C shows a cross-section view of the sidewall 41 which includes a foamed starch layer 42 and paper layers 44, 46 adhered to opposite surfaces of the foamed starch layer 42. These opposite surfaces are the inside and outside surfaces of the sidewall 41 of the cup 40 in FIG. 4A. The paper layers 44, 46 may be any suitable paper and are, in one aspect, paper as the paper 34 of the structure 30. The foamed starch layer 42 is material as in FIG. 1A that has been compressed to the thickness shown in FIG. 4C; but it is within the scope of this invention to use the un-compressed foamed starch material as shown in FIG. 1A in the sidewall 41. Either paper layer 44, 46 may be deleted.

The bottom 43 of the cup 40 may be made of any suitable cardboard, paperboard, or paper, including but not limited to, paper like the paper 34 of the structure 30 in FIG. 3. Alternatively, the bottom 43 may be made of any laminate or structure disclosed herein according to the present invention which includes a foamed starch layer. The cup is shown as generally cylindrical with a decreasing cross-sectional area from top to bottom, but it is within the scope of this invention for it to have a substantially uniform cross-sectional area from top to bottom. Instead of a cup, if a tubular member is desired, the bottom 43 is deleted.

FIGS. 5, 6, 7 disclose alternative sidewall structures for a cup or other container or receptacle according to the present invention. A cup 50 as shown in FIG. 5 has an outer wall 51 made, e.g. of cardboard. An end 51a of the outer wall 51 overlaps a portion of the wall 51 to sealingly enclose an inner foamed starch layer 52. The outer wall 51 (and an inner wall 53 described below adhered to an inner surface of the layer 52) is adhered to the exterior surface of the foamed starch layer 52 using any adhesive or glue disclosed herein or in any way disclosed herein, including but not limited to, wetting the outer surface of the foamed starch layer 52.

The upper wall 53 has an end 53a that overlaps a portion of the wall 53 to sealingly enclose the foamed starch layer 52. A bottom 55 may be made of any suitable paper, or cardboard or of any material or structure described herein with a foamed starch layer, as may, alternatively, either or both of the walls 51, 53.

FIG. 6 shows a cup or container 60 according to the present invention with an outer layer 61 made of multiple cardboard layers 61a and 61b that are spaced-apart by an undulating cardboard layer 61c to which both of the layers 61a and 61b are adhered at multiple spaced-apart points 61d.

A foamed starch layer 62 is positioned within the outer layer 61 and may be any foamed starch material, compressed or un-compressed, disclosed herein.

A barrier member, a paper layer 64, is adhered to the inner surface of the foamed starch layer 62 in any way and/or using any adhesive or glue disclosed herein. The paper layer 64 may be like the paper 34 of the cup 30 of FIG. 3.

A bottom 65 of the container 60 may be like the bottoms 43 or 53 described above. Alternatively, instead of the paper layer 64 another layer like the outer layer 61 may be used and adhered to the inner surface of the foamed starch layer 62.

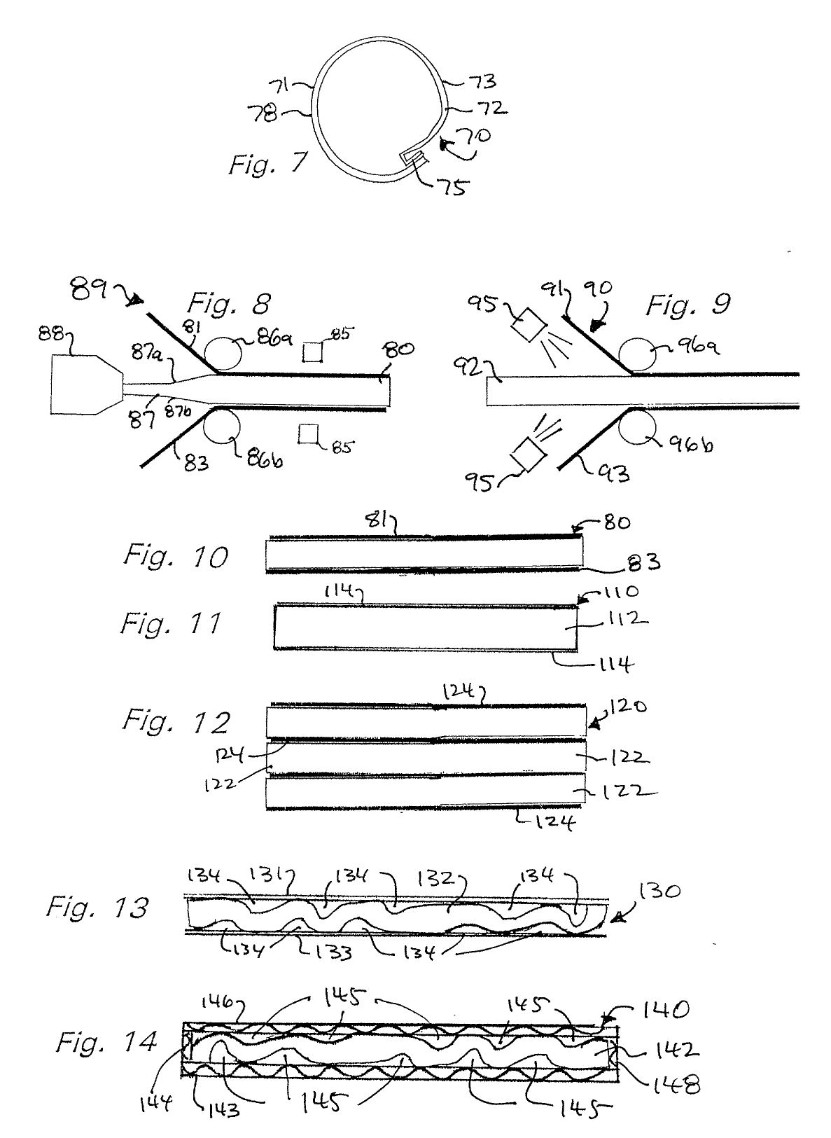

FIG. 7 shows a cup or container 70 according to the present invention, made from a laminate 78 according to the present invention, which has inner and outer layers 71, 73, respectively, between which is sandwiched a foam starch layer 72 to which each of the layers 71, 73 is adhered. An end 75 of the laminate 78 is folded back on itself and adhered to a portion of the laminate 78 to insure that no portion of the foamed starch layer 72 is exposed to contents of the cup 70. A bottom 73 is like the bottoms 43, 53, and 63 described above.

FIG. 8 shows a system 89 according to the present invention for making a structure 80 (see FIG. 10) according to the present invention. An extruder 88 extrudes a foamed starch material sheet 87 which exits the extruder 88 with moisture on surfaces 87a and 87b. This moisture is a result of the extrusion process itself. At this point the foamed starch is like the material as in FIG. 1A. Then paper, paperboard, or cardboard sheets 81, 83 are fed (e.g. by hand or from rolls of the material) between rotating rollers 86a and 86b which press the sheets 81, 83 onto opposite sides of the sheet 87 facilitating the adherence of the sheets 81, 83 to the surface of the sheet 87. The foamed starch sheet sticks to the paper due to the high moisture content of the starch as it exits from the extruder wet or “tacky” starch acts as a natural adhesive. The foamed starch exiting from the extruder is relatively hot, e.g., at about 115 degrees to 160 degrees Centigrade and this heat contributes to the adhering of the paper to the foamed starch layer. Moisture evaporating from the starch brings the temperature down to between about 95 degrees and 120 degrees Centigrade. The paper or cardboard sheets 81, 83 may be any suitable paper or cardboard, including but not limited to any paper or cardboard disclosed herein. The foamed starch layer 82 may be of the un-compressed type as in FIG. 1A or the rollers 86a, 86b may be positioned and tensioned to compress the foamed starch layer. Alternatively either the foamed starch layer may be compressed prior to the application of paper to its surfaces or it may be compressed with the paper in place. Optional cooling and/or drying apparatus 85 may be used to cool and/or dry the structure 80. Either sheet 81 or 83 may be deleted.

FIG. 9 shows a system 90 for producing a structure according to the present invention which may be any structure or item disclosed herein according to the present invention with a foamed starch sheet or layer. A foamed starch layer or sheet 92 is fed between rollers 96a and 96b while paper, paperboard, or cardboard sheets 91, 93 are also fed between the rollers. Spray apparatuses 95 spray water onto outer surfaces of the foamed starch sheet 92 for adhering the paper or cardboard sheets 91, 93 to the outer surfaces of the foamed starch layer 92. The spray apparatuses 95 in addition to, or instead of, spraying water may also spray other liquid to render the starch tacky, a water-based latex dispersion or solution, or other suitable aqueous or non-aqueous adhesives onto the layer 92. In both the systems 80 and 90 either of the paper, etc. sheets may be deleted.

FIG. 11 shows a foamed starch sheet 110 according to the present invention which includes a foamed starch layer 112 (like any foamed starch layer or sheet disclosed herein) to which has been applied a paper with a film of material 114. The film 114 may be applied by any suitable known film application device, system or apparatus and it may be applied to the paper prior to applying the paper to the foamed starch sheet or thereafter. The film 114 may be any suitable film, including, but not limited to, any water-resistant or water-protective film and any film disclosed in the following U.S. Pat. Nos. and in the prior art cited therein: 5,976,651 issued Nov. 2, 1999; 5,976,652 issued Nov. 2, 1999; 5,524,817 issued Jun. 11, 1996; 5,145,107 issued Sep. 8, 1992; 5,964,400 issued Oct. 12, 1999; and 5,769,311 issued Jun. 23, 1998—all of which are incorporated fully herein for all purposes. The film 114 may be deleted from either side of the layer 112.

FIG. 12 shows a multi-layer foamed starch structure 120 according to the present invention which has a series of foamed starch layers 122 one on top of the other with paper or cardboard 124 between each pair of adjacent layers 122 and paper or cardboard on the outer surfaces of the outer most layers 122. Any paper, paperboard, cardboard and foamed starch layers disclosed herein may be used and different paper, cardboard, paperboard, and/or foam starch layers may be used in a single structure 120. For example, the two outermost foamed starch layers 122 may be of the type shown in FIG. 4C and the innermost foamed starch layer 122 may be of the type shown in FIG. 1A. Also, it is within the scope of this invention to use two, three, four, or more foamed starch layers, one on top of the other. A multi-layer structure may be used for any of the walls, parts, etc. of any of the articles disclosed herein.

FIG. 13 shows a foamed starch structure 130 according to the present invention which has a central foamed starch layer 132 like that in FIG. 3 which has adhered to opposite outer surfaces thereof pieces of paper 131, 133. Captured between portions of the inner surfaces of the paper and portions of the foamed starch layer 132 are a plurality of air channels (if ends of the structure are not sealed off) or air pockets 134 (if ends of the structure are sealed off) both of which are within the scope of the present invention.

FIG. 14 shows a foamed starch structure 140 which has a central foamed starch layer 142 surrounded on sides and ends by cardboard layers (of which four are shown) 143, 144, 146, 148. Again layers of paper or cardboard or some other sealing material on the ends of the structure 140 are optional so that air channels or air pockets 145 are formed. Optionally the remaining two ends of the structure may also be sealed off with barrier members. Alternatively, the structure 140 (as may be any foamed starch structure disclosed herein) may be sealed within an integral sheet of paper, etc.

In the structures of FIGS. 13 and 14, as with any structure or layer according to the present invention, a film may be applied to outer and/or inner surfaces of any paper or cardboard piece or layer, including, but not limited to, a plastic film and/or water-resistant or water-protective film.

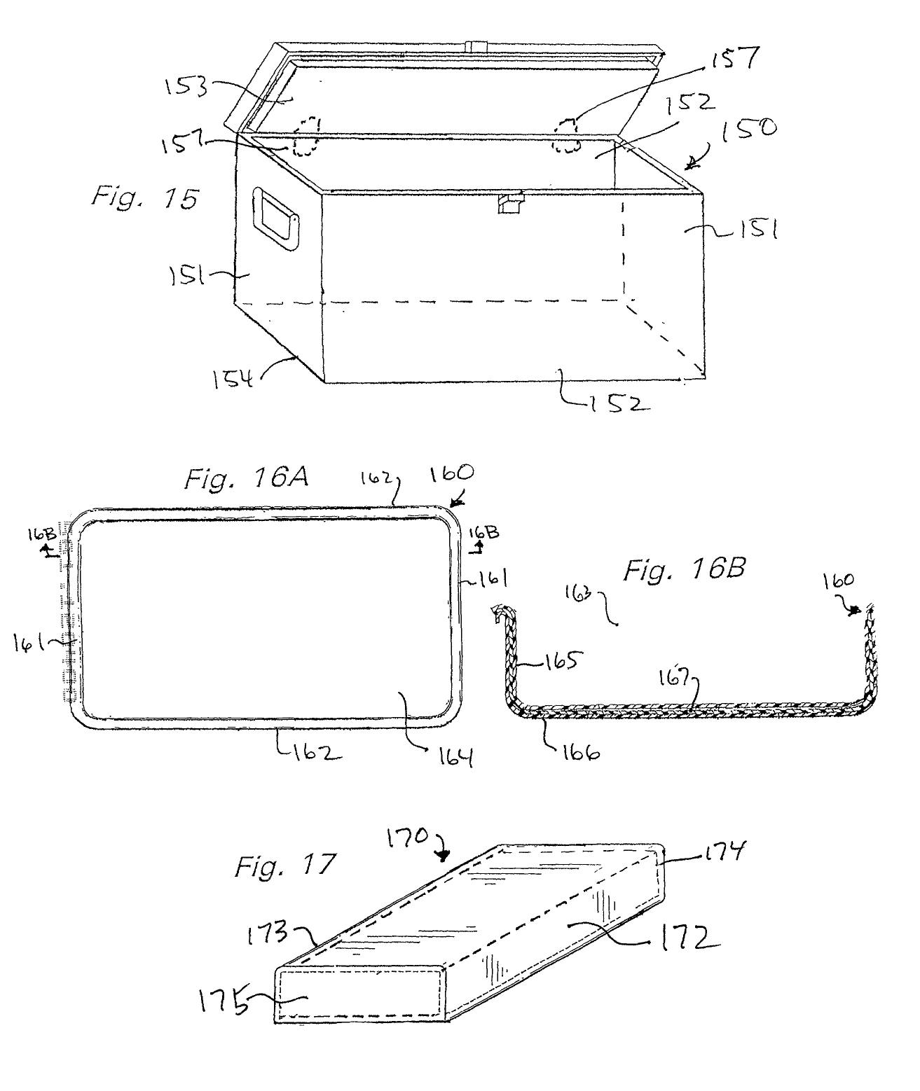

FIG. 15 shows a chest 150 according to the present invention with pairs of side walls 151, 152, a movable lid 153 and a bottom 154. Any or all of the side walls, lid, and bottom or portions thereof may include any foamed starch structure or layer disclosed herein according to the present invention. In one particular aspect, side walls, lid and bottom are all made of structures as in FIG. 4C or FIG. 14 with all surfaces of the foamed starch layer sealed with a moisture-resistant or moisture-protective film or sheet. The lid may be unattached to the chest 150 or, as shown, hingedly connected with hinges 157.

FIG. 16A shows a container 160 according to the present invention which has pairs of side walls 161, 162, a bottom 164 and an open top area 163. As shown in FIG. 16B, the side walls and bottom are made of a plurality of integral sheets or layers 165, 166, and 167. The layers 165, 167 are any paper or cardboard disclosed herein, with or without a protective film on their outer surfaces. The layer 167 is any foamed starch material, compressed or un-compressed, disclosed herein.

FIG. 17 shows a foamed starch structure 170 according to the present invention which has an inner foamed starch sheet or layer 172 (which may be any disclosed herein) which is completely and sealingly enclosed within barrier members 173, 174 and 175.

In certain methods according to the present invention a foamed is starch sheet or layer is produced using a known prior art extrusion system with an extruder like the extruder 88 in FIG. 8. The feed to the extruder, in certain aspects, is by weight between 70% to 95% dry starch (although wet starch may be used) and between 5% to 30% water, by weight. The water may be water present in the starch—dry or wet starch—and/or the water may be added separately to the starch prior to extrusion. Water, alcohol, and/or a mixture of aliphatic acids and carbonates (which produce carbon dioxide during the extrusion process), such as, but not limited to commercially available SAFOAM™ blowing agent from the Reedy International Corporation, may be used as the blowing agent to enhance bubble formation in the starch mass and to expand the starch. Steam produced during the extrusion process can condensate on the exiting foamed starch product providing the necessary moisture to adhere sheets, paper, paperboard, and/or cardboard to outer surfaces of the foamed starch layer. The final product foamed starch sheet or layer contains typically about 72% to 96% starch (or starch plus synthetic polymeric material as described below) and about 4% to 28% water.

In certain embodiments a particulate nucleating or “bubbling” agent, e.g. but not limited to talc, calcium carbonate, and silica, is also introduced into the extruder system to enhance the formation of cells or bubbles of desirable size within the foamed starch layer or sheet, to reduce the sheet's density, and to reduce the number of larger volume undesirable cells. Typically about 0.05 to about 5% (of the total extruder feed) by weight of such a nucleating agent is used.

In certain aspects a plasticizer is also fed to the extruder to enhance formation of a desired mass of foamed starch for extrusion. Plasticizers lower the melting temperature of the starch and inhibit charring or burning of it. Plasticizers which may be used include, but are not limited to water, polyethylene glycol, glycerine, and thalate esters, or combinations thereof. Typically, the amount of plasticizer is between about 0.5% and 40% by weight of the feed to the extruder. Also synthetic polymeric material, described in detail below, may be added to the extruder feed.

A typical annular die may be used with the extruder which produces the foamed starch layers described herein, e.g. as in FIG. 1A. Alternatively, a “strand” die may be used which produces a multiplicity of strands each flowing out from one of a plurality of holes in the die and which exit the die together and form a foamed starch sheet.

In certain aspects of the present invention, any foamed starch layer or sheet according to the present invention may contain an amount of selected synthetic polymeric material—strengtheners, tougheners, or modifiers—polyhydroxy amino ether (“PHAE”) resins and/or polyvinyl alcohol polymers. Certain of these materials are described in U.S. Pat. No. 5,275,853 issued Jan. 4, 1994 which is co-owned with the present invention and fully incorporated herein for all purposes. In certain particular embodiments the synthetic polymeric material is any one of the following hydroxy-functional polyethers:

(1) poly(hydroxy ethers) having repeating units represented by the formula:

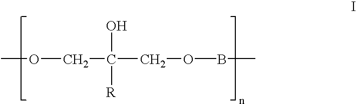

(2) poly(hydroxy amino ethers) having repeating units represented by the formula:

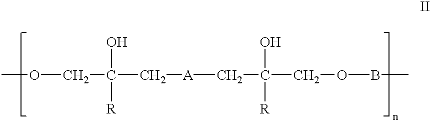

(3) poly(hydroxy ether sulfonamides) having repeating units represented by the formula:

[chemical structure]

(4) poly(hydroxy ether sulfides) having repeating units represented by the formula:

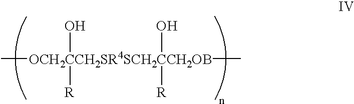

(5) poly(hydroxy amide ethers) having repeating units represented independently by any one of the formulas:

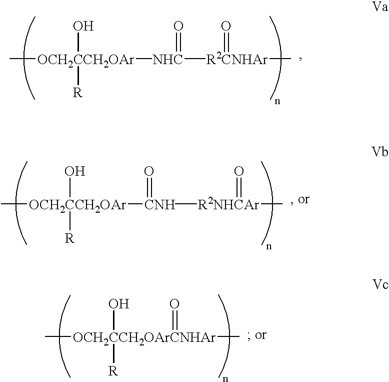

(6) poly (hydroxy amide ethers) having repeating units represented by any one of the formulas:

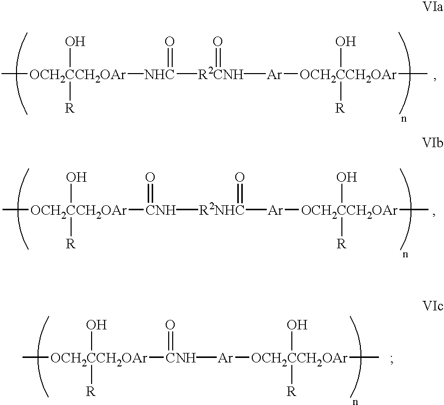

wherein R is alkyl or hydrogen; R¹ and R³ are independently a substituted or an unsubstituted alkyl or aryl wherein the substituent(s) is a monovalent moiety which is inert in the reactions used to prepare the hydroxy-functionalized polyethers, such as cyano, halo, amido, hydroxy and hydroxyalkyl; Ar is a divalent aromatic moiety; A is a diamino moiety or a combination of different amine moieties; B, R², and R⁴ are independently a divalent organic moiety which is predominantly hydrocarbylene; and n is an integer from 5 to 1000.

The term “predominantly hydrocarbylene” means a divalent radical which is predominantly hydrocarbon, but which optionally contains a minor amount of heteroatomic moiety such as oxygen, sulfur, imino, sulfonyl, and sulfoxyl.

In a preferred embodiment of the present invention, R is hydrogen; R¹ and R³ are independently methyl, ethyl, propyl, butyl, 2-hydroxyethyl or phenyl; Ar, B, R² and R⁴ are independently 1,3-phenylene, 1,4-phenylene, sulfonyldiphenylene, oxydiphenylene, thiodiphenylene or isopropylidenediphenylene; A is 2-hydroxyethylimino, 2-hydroxypropylimino, piperazenyl or N,N′-bis(2-hydroxyethyl)-1,2-ethylenediimino.

The hydroxy-functional polyethers having repeating units represented by Formula I are prepared, for example, by contacting a diglycidyl ether or a combination of diglycidyl ethers with a dihydric phenol or combination of dihydric phenols using the process described in U.S. Pat. No. 5,164,472. Alternatively, the poly(hydroxy ethers) are obtained by allowing a dihydric phenol or a combination of dihydric phenols to react with an epihalohydrin by the process described by Reinking, Barnabeo, and Hale in the Journal of Applied Polymer Science, Volume 7, page 2135 (1963). Preferably the poly(hydroxy ether of Formula I is a poly(hydroxy phenoxyether)

The polyetheramines having repeating units represented by Formula II are prepared by contacting one or more of the diglycidyl ethers of a dihydric phenol with a difunctional amine (an amine having two amine hydrogens) under conditions sufficient to cause the amine moieties to react with epoxy moieties to form a polymer backbone having amine linkages, ether linkages and pendant hydroxyl moieties. These polyetheramines are described in U.S. Pat. No. 5,275,853. The polyetheramines can also be prepared by contacting a diglycidyl ether or an epihalohydrin with a difunctional amine.

The hydroxy-functional poly(ether sulfonamides) having repeating units represented by Formulas IIIa and IIIb are prepared, for example, by polymerizing an N,N′-dialkyl or N,N′-diaryldisulfonamide with a diglycidyl ether as described in U.S. Pat. No. 5,149,768.

The hydroxy-functional polyethers having repeating units represented by Formula IV are prepared by reacting a diglycidyl ether and a dithiol as described in U.S. Pat. Nos. 4,048,141 and 4,171,420.

The poly(hydroxy amide ethers) represented by Formula V are prepared by contacting a bis(hydroxyphenylamido)alkane or arene, or a combination of 2 or more of these compounds, such as N,N′-bis(3-hydroxyphenyl)adipamide or N,N′-bis(3-hydroxyphenyl)glutaramide, with an epihalohydrin as described in U.S. Pat. No. 5,134,218.

The poly(hydroxy amide ethers) represented by Formula VI are preferably prepared by contacting an N,N′-bis(hydroxyphenylamido)alkane or arene with a diglycidyl ether as described in U.S. Pat. Nos. 5,089,588 and 5,143,998.

The hydroxy-functional polyethers available from Phenoxy Associates, Inc. are also suitable for use as the base polymer in the practice of the present invention. These polymers and the process for preparing them are described in U.S. Pat. Nos. 3,305,528 and 5,401,814.

In certain aspects the synthetic polymeric material is co-added to the extruder feed, e.g. by pre-blending with the starch or by introducing it to the extruder from a separate source that feeds the polymeric material into the extruder at a level of about 2% to about 20% by weight of the total feed to the extruder. Although PHAE resins do not biodegrade at a rate similar to that of starch, they are present in a final product such as the cups, containers and structures described herein at such a level that the overall biodegradability of the products is acceptable and significantly higher than that of certain prior art products (e.g. those made of foamed polystyrene).

Various specific cups, boxes, structures and containers have been described above. However, it is within the scope of this invention to produce a wide variety of structures, receptacles, and containers using any of the foamed starch sheets, layers, and/or structures according to the present invention, including, but not limited to, trays, plates, egg cartons, poster board, foam board, take-out food containers, clam shell containers, ice chests, drink holders and flotation devices.

It is within the scope of this invention to add to any foamed starch sheet, layer, or product according to the present invention those additives that are well known in the prior art as additives to starch, such as, but not limited to, pigments, dyes, waxes, lubricants, anti-static agents and processing aids. It is within the scope of this invention to form any foamed starch sheet, layer or structure disclosed herein by a thermoforming process in which the foamed starch is softened by heat or by heat and moisture and formed into a shape by the application of pressure, gravity, vacuum, and/or mechanical or other means to conform the material to the shape of a mold surface. It is within the scope of this invention for any foamed starch structure disclosed herein which has two barrier members, one on one surface of a foamed starch piece and one on another surface of the foamed starch piece, to have each barrier member made from different material, e.g. but not limited to a first barrier member made of paper and a second barrier member made of cardboard or a first barrier member made of flexible sheet material (e.g. plastic, rubber, etc.) and a second barrier member made of paperboard.

In conclusion, therefore, it is seen that the present invention and the embodiments disclosed herein are well adapted to carry out the objectives and obtain the ends set forth. Certain changes can be made in the subject matter without departing from the spirit and the scope of this invention. It is realized that changes are possible within the scope of this invention and it is further intended that each element or step disclosed here is to be understood as referring to all equivalent elements or steps. The invention disclosed herein is new and novel in accordance with 35 U.S.C. §102 and satisfies the conditions for patentability in §102. The invention disclosed herein is not obvious, in accordance with 35 U.S.C. §103 and satisfies the conditions for patentability in §103. This specification is in accordance with all of the requirements of 35 U.S.C. §112. The inventors may rely on the Doctrine of Equivalents to determine and assess the scope of their invention as it may pertain to apparatus not materially departing from, but differing from, the embodiments of the invention as disclosed herein in one or more aspects.

1. An article of manufacture comprising
a sheet of foamed mixture of starch and an amount of at least one of the polymers of formulas I-VIc or of polyvinyl alcohol polymer, and
a first barrier member adhered to the sheet.

2. The article of manufacture of claim 1 wherein
the sheet has a first side and second side, the first side spaced apart from the second side, the barrier member adhered to the first side of the sheet and the article of manufacture further comprising
a second barrier member, the second barrier member adhered to the second side of the sheet.

3. The article of manufacture of claim 1 wherein the first barrier member is adhered to the sheet with an adhesive.

4. The article of manufacture of claim 1 wherein the first barrier member is a sheet from the group consisting of paper, paperboard, cardboard, plastic, rubber, fiberglass and polytetrafluoroethylene.

5. The article of manufacture of claim 1 wherein the sheet has a plurality of alternating undulations.

6. The article of manufacture of claim 1 wherein the sheet has two substantially flat spaced-apart outer surfaces.

7. The article of manufacture of claim 1 wherein the first barrier member encloses the sheet.

8. The article of manufacture of claim 7 wherein the first barrier member comprises a plurality of sealingly-connected sub-barrier members encompassing the sheet.

9. The article of manufacture of claim 1 wherein the first barrier member is water resistant.

10. The article of manufacture of claim 1 wherein the first barrier member has an exposed outer surface not in contact with the sheet, the article of manufacture further comprising
a protective film on the exposed outer surface of the first barrier member.

11. The article of manufacture of claim 10 wherein the protective film is liquid resistant.

12. The article of manufacture of claim 1 wherein the sheet and the first barrier member are flexible so that the article of manufacture is flexible.

13. The article of manufacture of claim 5 wherein the undulations comprise a plurality of alternating ridges and valleys and wherein portions of the first barrier member cover and seal off the valleys so that a plurality of spaced-apart air spaces within the article of manufacture are defined by portions of an inner surface of the first barrier member and an outer surface of each of the valleys.

14. The article of manufacture of claim 13 wherein the sheet has a first side and second side, the first side spaced apart from the second side, the first barrier member adhered to the first side of the sheet and the article of manufacture further comprising a second barrier member, the second barrier member adhered to the second side of the sheet, and wherein portions of the barrier members cover and seal off the valleys on their respective side of the sheet so that a plurality of spaced-apart air spaces within the article of manufacture are defined by portions of an inner surface of each the barrier members and an outer surface of each of the valleys on a side of the sheet.

15. The article of manufacture of claim 1
wherein the sheet of foamed mixture of starch and polymer comprises at least one poly(hydroxy amino ether) of formula II, and
wherein the first barrier member is a sheet from the group consisting of plastics, rubber, fiberglass, polytetrafluroethylene, paper, paperboard, and cardboard, and
wherein the first barrier member is water resistant.

16. An article of manufacture comprising
a plurality of adjacent sheets of foamed mixture of starch and an amount of at least one of the polymers of formulas I-VIc or of polyvinyl alcohol polymer, the plurality of adjacent sheets having a top most sheet with a top-most outer surface and a bottom-most sheet with a bottom-most outer surface, and adjacent sheets having adjacent inner surfaces within the article of manufacture,
a top-most barrier member adhered to the top-most outer surface of the top-most sheet, and
a bottom-most barrier member adhered to the bottom-most surface of the bottom-most sheet.

17. The article of manufacture of claim 16 further comprising
at least one inner barrier between each of the adjacent inner surfaces of sheets.

18. The article of manufacture of claim 17 wherein the at least one inner barrier is adhered to one of the sheets.

19. A container comprising
a receptacle member for holding contents, the receptacle member comprising at least one sidewall and a bottom member connected to the side wall, the at least one sidewall and the bottom member defining an enclosed space for holding the contents, the enclosed space having an open top through which the contents are movable into and out of the container,
the at least one sidewall made of a structure comprising
a sheet of foamed mixture of starch and an amount of at least one of the polymers of formulas I-VIc or of polyvinyl alcohol polymer, and
a first barrier member adhered to the sheet.

20. The container of claim 19 wherein the receptacle member has an inner surface defined by a surface of the first barrier member of the at least one sidewall, the container further comprising
a liquid resistant film on the inner surface of the receptacle member.

21. The container of claim 19 wherein the sheet has a first side and second side, the first side spaced apart from the second side, the barrier member adhered to the first side of the sheet and the article of manufacture further comprising a second barrier member, the second barrier member adhered to the second side of the sheet and wherein the receptacle has an outer surface defined by an outer surface of the second barrier member.

22. The container of claim 19 wherein the bottom member is made from a structure comprising
a sheet of foamed mixture of starch and an amount of at least one of the polymers of formulas I-VIc or of polyvinyl alcohol polymer, and
at a first barrier member adhered to the sheet.

23. The container of claim 19 wherein the first barrier member is a sheet from the group consisting of rubber, plastic, polytetrafluoroethylene, paper, paperboard, fiberglass and cardboard.

24. The container of claim 19 wherein the sheet has a plurality of alternating undulations.

25. The container of claim 19 wherein the sheet has two substantially flat spaced-apart outer surfaces.

26. The container of claim 19 wherein the first barrier member has an overlap portion that overlaps another portion of the first barrier member.

27. The container of claim 19 wherein the at least one sidewall comprises a plurality of interconnected sidewalls.

28. The container of claim 19 wherein a beverage cup.

29. The beverage cup of claim 28 wherein the sheet of foamed mixture of starch and a polymer comprises at least one poly(hydroxy amino ether) of formula II.

30. The container of claim 19 comprising a chest with a lid movably connected thereto for selectively closing off the open top.

31. A method for making an article of manufacture, the article of manufacture comprising a sheet of foamed mixture of starch and an amount of at least one of the polymers of formulas I-VIc or of polyvinyl alcohol polymer, and a first barrier member adhered to the sheet, the method comprising
adhering a first barrier member to the sheet.

32. The method of claim 31 further comprising
foaming the starch and polymer in an extruder, and extruding the sheet from the extruder.

33. The method of claim 32 wherein water is used as a foaming agent in the extruder and the sheet exits the extruder with a tacky adhesive outer surface due to the water, the method further comprising
adhering the first barrier member to the tacky adhesive outer surface of the sheet.

34. The method of claim 31 wherein the sheet has a first side and second side, the first side spaced apart from the second side, the barrier member adhered to the first side of the sheet and the article of manufacture further comprising a second barrier member, the second barrier member adhered to the second side of the sheet and the method further comprising
adhering the second barrier member to the second side of the sheet.

35. The method of claim 31 further comprising
drying the sheet.

36. The method of claim 31 further comprising
applying adhesive to an outer surface of the sheet, and
adhering the first barrier member to the outer surface of the sheet with the adhesive.

37. The method of claim 34 further comprising
applying adhesive to the second side of the sheet, and
adhering the second barrier member to the second side with the adhesive.

38. The method of claim 31 further comprising
applying water to an outer surface of the sheet, and
adhering the first barrier member to the outer surface of the sheet.

39. The method of claim 34 further comprising
applying water to the second side of the sheet, and
adhering the second barrier member to the second side.

40. The method of claim 37 further comprising
feeding the sheet and the first and second barrier between dual opposed spaced-apart rollers to facilitate adherence of the barrier members to the sheet.

41. The method of claim 39 further comprising
feeding the sheet and the first and second barrier between dual opposed spaced-apart rollers to facilitate adherence of the barrier members to the sheet.

42. The method of claim 31 further comprising
making the sheet and including in it at least one poly(hydroxy amino ether) of formula II.

43. The method of claim 31 wherein the first barrier member is a sheet from the group consisting of paper, paperboard, cardboard, plastic, rubber, fiberglass and polytetrafluoroethylene.

44. The method of claim 43 wherein the sheet is flexible.

45. The method of claim 43 wherein the sheet is rigid.
